(19) United States
(12) Patent Application Publication
(10) Pub. No.: US 2025/0298163 A1
(43) Pub. Date: Sep. 25, 2025

(54) RESERVOIR PROPERTY MODELING USING A DECISION FOREST WITH MULTIPLE VARIABLES AND POWERS

(71) Applicant: Schlumberger Technology Corporation, Sugar Land, TX (US)

(72) Inventors: Colin Daly, Abingdon (GB); Timothy Yeo, Menlo Park, CA (US); John Godlewski, Menlo Park, CA (US)

(21) Appl. No.: 19/087,025

(22) Filed: Mar. 21, 2025

Related U.S. Application Data
(60) Provisional application No. 63/568,385, filed on Mar. 21, 2024.

(51) Int. Cl. G01V 1/28; G06N 20/20

(52) U.S. Cl. CPC G01V 1/282; G06N 20/20; G01V 2210/665

(57) ABSTRACT

Systems and methods herein include a method for reservoir property modeling, comprising training an ML decision tree ensemble on sample data, to generate a trained decision forest; computing, by the trained decision forest, an envelope for target variables at one or more target locations based on at least one variable; and executing a conditional simulation by using the at least one variable to compute a target variable of the target variables by sampling from the envelope based on a sampling variable.

### CROSS-REFERENCE TO RELATED APPLICATIONS

This application claims the benefit of and priority to U.S. Provisional Patent Application No. 63/568,385, filed on Mar. 21, 2024, the entire contents of which are hereby incorporated by reference.

### BACKGROUND

### Field

Aspects of the present disclosure relate to petroleum reservoir monitoring, and in particular, to modeling reservoir properties.

### Description of Related Art

Modeling properties of a gas or petroleum reservoir may utilize reservoir property models (also known as reservoir characterization models), which include three-dimensional representations of a subsurface hydrocarbon reservoir, including the spatial distribution of one or more petrophysical, geological or geophysical properties or attributes of the hydrocarbon reservoir. A reservoir property model quantifies properties or attributes within a subsurface volume that encompasses the hydrocarbon reservoir.

These properties or attributes typically include the structural shape and thicknesses of the formation layers within the subsurface volume being modeled, their lithologies, and the porosity and permeability distributions. These attributes are relatively stable over long periods of time and can, therefore, be considered static. Porosity and permeability often vary significantly from location to location within the volume, resulting in heterogeneity. However, porosity and permeability are stable in the near-geologic timeframe and do not change due to the movement of fluids or gases through any of the formations pore spaces. The reservoir property model is also commonly referred to as a static or geologic model.

The properties and attributes of the reservoir property model are typically defined by extrapolation from physical and chemical data related to the reservoir, including core data, well log data and seismic data. Computer-based methods and systems typically create a reservoir property model from relevant datasets that pertain to the reservoir. These datasets are compiled to create stratigraphic and structural frameworks that define the geometry of the reservoir. Using these frameworks, the facies, porosity, and permeability values are extrapolated horizontally and vertically throughout each layer. For example, the facies of various rock types are typically modeled independently within each stratigraphic layer whereas the porosity of the model is dependent upon the facies model. Permeability is dependent upon both the facies and the porosity models. Several reservoir property models can be created from these attributes and then evaluated to select one or more “best” reservoir property models. The selected reservoir property model(s) can be used to simulate fluid flow in the reservoir during production.

Geostatistics is a class of statistics used to estimate and predict spatially continuous phenomena using data recorded at a limited number of spatial locations. Geostatistics is a tool used to analyze and predict the values associated with modeling reservoir properties. Geostatistical tools incorporate spatial coordinates of the data within the analysis and rely on statistical models that are based on random function theory to model the uncertainty of special estimation and simulation.

Many geostatistical tools were originally developed to describe spatial patterns and extrapolate values for locations within the subsurface where sampled data was not recorded. Those tools and methods have evolved to provide interpolated values and measurements of uncertainty for values. The measurements of uncertainty are relied upon by geoscientists to make informed decisions in monitoring existing petroleum reservoirs under production and determine the locations of other potentially suitable petroleum reservoirs. As described herein, reservoir properties and attributes to be computed or estimated are referred to as target variables.

### SUMMARY

One aspect provides a method for reservoir property modeling, comprising training a machine learning (ML) decision tree ensemble on sample data, to generate a trained decision forest; computing, by the trained decision forest, an envelope for target variables at one or more target locations based on at least one variable; and executing a conditional simulation by using the at least one variable to compute a target variable of the target variables by sampling from the envelope based on a sampling variable.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example flow diagram of a method for determining target variables that represent properties of a subsurface.

FIG. 2 depicts a flowchart of training operations of a machine learning (ML) ensemble that predicts a value of a target variable.

FIG. 3 depicts an example training operation of an ML ensemble (ensemble of ML models).

FIGS. 4-8 display example results obtained from executing the method of FIG. 1 for various intervention variables and intervention powers.

FIG. 9 depicts an example method for reservoir property modeling.

FIG. 10 depicts an example processing system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for modeling subsurface properties of a petroleum reservoir, including, for example, porosity, permeability, and initial water saturation.

Geostatistics have been traditionally used to estimate subsurface properties, e.g., in reservoir modeling, such as porosity, permeability, liquid flows, and water saturation, from data recorded at sparse locations, such as core, log, and test data at the well sites and seismic data recorded in the field. However, the subsurface properties obtained using geostatistics alone often fail to correctly characterize reservoir boundaries and fail to detect additional reservoirs within the same region of a subsurface. As a result, properties obtained from geostatistical methods alone cannot always be relied upon to monitor reservoir production and identify new petroleum deposits. Current reservoir modeling methods and systems produce reservoir property models with uncertainties that can impact the accuracy of the follow-on production reservoir simulation operations. Therefore, there is a need for improved systems and methods to produce accurate reservoir property models.

Methods described herein are directed to reservoir property modeling that combines geostatistics with a decision forest obtained using ML to accurately determine a three-dimensional reservoir property model of a subsurface volume or region. A decision forest is an ensemble of decision trees. A decision tree is a non-linear ML model that models a classification or regression problem as a series of binary “decisions” based on input features that leads to a result stored in the tree's leaf nodes. Typically, thresholds for making decisions are selected for continuous variables to form binary decisions at each decision node while values for categorical variables may be mapped to each branch. Examples of ML algorithms for learning decision trees include the Iterative Dichotomiser 3 (ID3) algorithm, the C4.5 algorithm, CART, or other suitable algorithms. One significant disadvantage of decision trees is that they are often prone to over-fitting, leading to increased generalization error. To overcome this problem, ensemble learning methods have been developed that combine an ensemble of decision tree ML models (ML decision tree ensemble) into a decision forest.

Reservoir property modeling with the systems and methods described herein has the advantage of accurately estimating unknown subsurface properties (target variables) such as porosity, permeability, and initial water saturation of a subsurface using limited data (such as core, log, and test data) at the well locations and field data (such as seismic data) recorded in a land survey. The resulting reservoir property model from combining geostatistics and decision forest outputs as described below, more accurately captures porosity, permeability, liquid flows, and water saturated regions of the spatial locations within the subsurface than using geostatistics alone. As a result, the reservoir property model of porosity, permeability, liquid flows, and water saturation can be used by geoscientists to plan and organize production of reservoirs within the subsurface.

Furthermore, described herein are methods to train and utilize a decision forest to derive a conditional distribution (envelope) for a target variable for each target location the target variable is to be estimated. For a conditional simulation of the target variable, the envelope needs to be sampled from using a sampling variable. Additionally, systems and methods are described to run a conditional simulation of the target variable by intervening to modify or bias the sampling from the envelope using the multiple intervention variables and powers. The intervention variable can be either external variables, selected from the secondary input variables used for training, or a combination of both. The intervention power is the assigned strength of relationship between the target and the intervention variable for generating the sampling variable. Beneficially, the described systems and methods generate a more realistic target field. The target field describes the range of possible correct outputs for a target variable. Furthermore, the described systems and methods can also be used to generate multiple realizations (e.g., simulations of the model) with various plausible modeling scenarios by merely adjusting the intervention variables and powers. For example, this allows the generation of a larger number of realistic models with the same sampling data via the conditional simulation that is executed.

Additionally, reservoir property model(s) described herein can be used to simulate fluid flow in the reservoir during production via a fluid flow simulator. The fluid flow simulator can be used to plan and optimize production of hydrocarbons from the reservoir. Results of the fluid flow simulator optimize the production of oil and natural gas from the regions of the subsurface. The results of the fluid flow simulator are used to plan and organize oil and natural gas production in the regions.

### Example Method of Reservoir Property Modeling

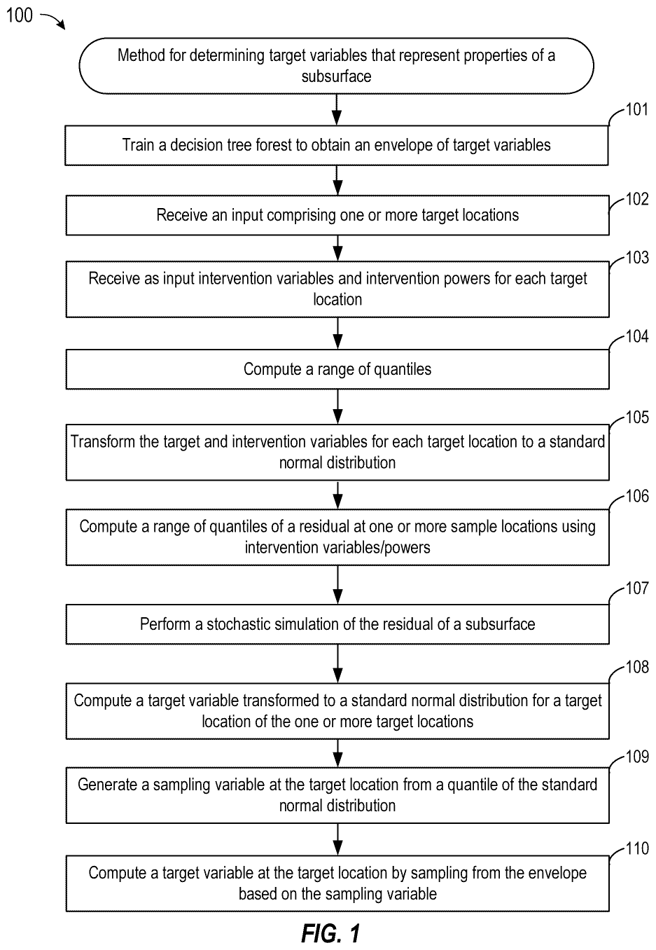

FIG. 1 is a flow diagram of a method 100 for determining target variables that represent properties of a subsurface using multiple intervention variables and powers. The proposed method may be performed on computing devices and systems including but not limited to modeling software such as an embedded model simulator EMBER™ which can combine a decision forest with embedded geostatistics for three-dimensional reservoir property modeling. Method 100 includes training a decision forest, which is used to derive an envelope, and then running a conditional simulation of the target variable by intervening to modify or bias the sampling from the envelope using the multiple intervention variables and powers to derive modeling of the target variable.

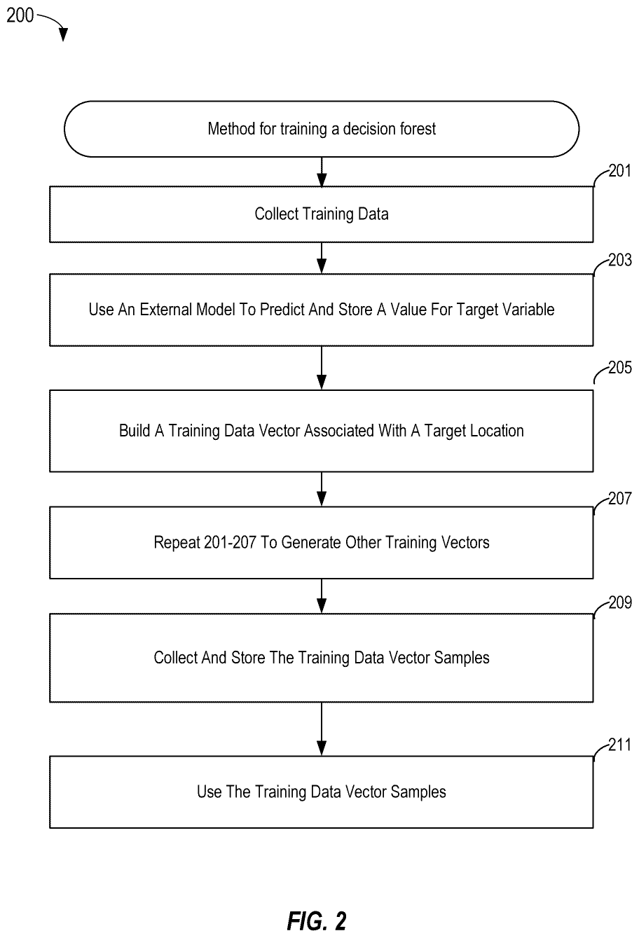

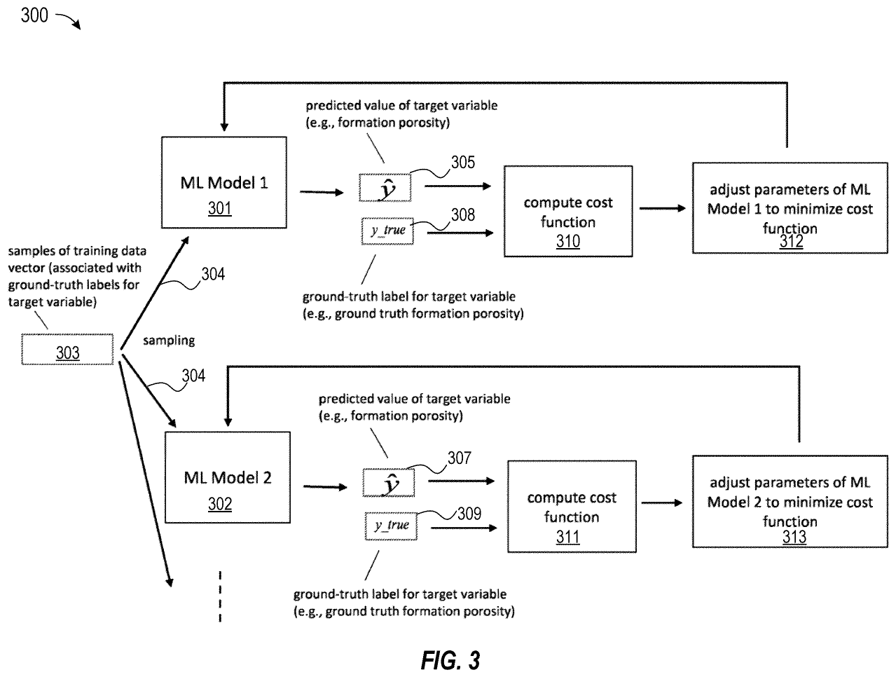

In block 101, a decision forest is trained using ML. The decision forest is an ML decision tree ensemble trained using sample data that includes various secondary variables, such as seismic attributes, geometrical data, and embedded variables. Sample data may be a subset of collected training data. In some aspects, methods for training the decision forest may be as described in FIGS. 2-3 and in U.S. Publication No. 2023/0358917, which is incorporated herein by reference in its entirety. In many practical applications, two embedded variables generated from the cross-validated short and long-range kriging estimations may be used to inject a spatial component into the decision forest training process. Kriging also known as Gaussian process regression, is a method of interpolation based on a Gaussian process governed by prior covariances. For example, Kriging predicts the value of a function at a given point by computing a weighted average of the known values of the function in the neighborhood of the point.

In some aspects, after training the decision forest, the secondary variables (plus embedding variables) are input to the trained decision forest to compute an approximated conditional distribution for a target variable. An embedding variable is a representative variable or value, e.g., a representation of data in a lower-dimensional space. The target variable is the variable to be estimated or determined. In some examples, the target variable can be porosity, permeability, degree of water saturation, or another property of the subsurface. The family of conditional distributions for the target variable is referred to herein as an “envelope”. The blocks 102-110 of method 100 describe running or executing a conditional simulation of the target variable by intervening to modify or bias the sampling from the envelope using the multiple intervention variables and powers.

In block 102, one or more target locations, e.g., regions of the subsurface, are selected by a user and received as input. Each region corresponds to a volume of the Earth. A target location is a selected location where a target variable needs to be estimated.

In block 103, intervention variables and intervention powers associated with each selected target location are received as input. For example, the intervention variables and intervention powers may be selected or input by a user on a computing device executing an application for reservoir property modeling. The intervention variables can be external variables selected from the secondary variables used for training the decision forest. An intervention power is the correlation between the target variable and the intervention variables for computing the sampling variable U(x) at the target location x described below with reference to block 109. In some cases, the sampling variable may be derived from the transform of the standard normal distribution. The secondary variables which an intervention variable is selected from may characterize a geophysical attribute or property (such as seismic attributes) at a location in a reservoir.

In block 104, conditional simulation is run to compute a range of quantiles (q_{low}, q_{high}) that maintains sample data of the envelope at each sample location. A sample location is a training location, that is, they are locations when the variable to be estimated/simulated (known as the Target variable) is known. These are typically well locations. Target locations are locations where the Target variable is not observed and needs to be simulated/estimated. Secondary data is assumed to be known at all locations, at both sample and target locations. A region is a set of spatial locations. The intervention variables can be set to be per region if required.

In block 105, the target variable and selected intervention variables for each target location are transformed to the standard normal distribution.

In block 106, the ranges of quantiles of the residual (q_{res,low}, q_{res,high}) are computed at each sample location using the intervention variables and the intervention powers as follows:

$${q}_{res , r} = G ( \frac{{G}^{- 1} ( {q}_{r} ) - {μ}_{c}}{{σ}_{c}} ) \qquad ( 1 )$$

where
   r=low, high;
   G is the cumulative standard normal distribution,
   G⁻¹ is the inverse function of G, and
   μ_{c} and σ_{c} are the conditional mean and standard deviation, respectively, for a multivariate normal distribution.
      The mean for the multivariate normal distribution is computed by:

$${μ}_{c} = {\sum }_{j = 1}^{N} {λ}_{j} {y}_{j} \qquad ( 2 )$$

and the standard deviation of the multivariate normal distribution is computed by:

$${σ}_{c} = \sqrt{1 - {\sum }_{j = 1}^{N} {λ}_{j} {ρ}_{j}} \qquad ( 3 )$$

Eq. (3) applies the constraint that 1−Σⱼ₌₁^{N}λⱼρⱼ>0. The parameter N is the total number of selected intervention variables with yⱼ representing the j-th intervention variable transformed to the standard normal distribution. The parameter λⱼ is a weighting of the intervention variable yⱼ. The parameter ρⱼ is the intervention power of the intervention variable yⱼ. The intervention powers ρᵢ=ρ₀ᵢ, i∈[1, N] are selected by the user for each region. The weightings λⱼ can be derived by solving the following matrix equation:

$$C Λ = [ \begin{matrix}{C}_{11} & {C}_{12} & ⋯ & {C}_{1 N} \\ {C}_{21} & {C}_{22} & ⋯ & {C}_{2 N} \\ ⋮ & ⋮ & ⋮ & ⋮ \\ {C}_{N 1} & {C}_{N 2} & ⋯ & {C}_{NN}\end{matrix} ] [ \begin{matrix}{λ}_{1} \\ {λ}_{2} \\ ⋮ \\ {λ}_{N}\end{matrix} ] = [ \begin{matrix}{C}_{1} \\ {C}_{2} \\ ⋮ \\ {C}_{N}\end{matrix} ] = {C}_{0} \qquad ( 4 )$$

The matrix C on the left-hand side of Eq. (4) is the variance-covariance matrix. The matrix elements Cᵢⱼ, i, j∈[1, N], of the variance-covariance matrix are the covariance between the i-th intervention variable, yᵢ, and the j-th intervention variable, yⱼ. The column vector C₀ on the right-hand side of Eq. (4) contains the covariances between the target variable, y₀, and the intervention variables yⱼ. The variance-covariance matrix C is positive-definite. The covariance vector C₀ is equivalent to the correlation when the target and intervention variables are transformed to the standard normal distribution.

In block 107, a conditional stochastic simulation of the residual is performed. For the decision forest, a suitable algorithm, such as Turning Bands, is used for unconditional simulation that generates Gaussian noise, E₀, and kriging for conditioning to the sample data as follows:

$${z}_{i} = Z ( {x}_{i} ) = {F}_{xi}^{- 1} ( {u}_{i} ) \qquad ( 5 )$$

where
   zᵢ is the target variable at the sample location xᵢ; and
   Fₓᵢ⁻¹ is the inverse cumulative distribution function of the envelope at the sample location xᵢ. Turning bands refers to a method used in geostatistics to simulate complex, multi-dimensional random fields by generating a series of one-dimensional simulations along lines rotated in different directions.

A quantile of the residual, qᵣₑₛ, is randomly sampled from a quantile range [q_{res,low}, q_{res,high}]. The residual at the sample location, Rᵢ, is computed as follows:

$${q}_{res} = ( 1 - ran ) \times {q}_{res , low} + ran \times {q}_{res , high} \qquad ( 6 )$$

$${R}_{i} = {G}^{- 1} ( {q}_{res} ) \qquad ( 7 )$$

where ran is a random variable in the interval [0,1]. The parameter R̅ᵢ=Rᵢ−E₀ᵢ is computed at each sample location and a field R̅(x) at the target location x is computed using kriging.

In block 108, at the target location x, the target variable that is transformed to the standard normal distribution Z_{G}(x) is computed as follows:

$${Z}_{G} ( x ) = ( \overline{R} ( x ) + {E}_{0} ( x ) ) \times {σ}_{c} + {μ}_{c} \qquad ( 8 )$$

In block 109, the sampling variable U(x) at the target location x is computed from the quantile of the standard normal distribution as follows:

$$U ( x ) = G ( {Z}_{G} ( x ) ) \qquad ( 9 )$$

In block 110, the target variable at the target location x is computed by sampling from the envelope of the distribution using the generated by sampling variable U(x) as follows:

$$Z ( x ) = {F}_{x}^{- 1} ( U ( x ) ) \qquad ( 10 )$$

where Fₓ⁻¹ is the inverse cumulative distribution function of the envelope at the target location x.

The method of FIG. 1 may be repeated for each target location of the subsurface to obtain multiple target variables at different target locations of the subsurface. The target variables computed in the method of FIG. 1 are geologically consistent because the target variables are sampled from the envelope. Note that by changing the intervention variables and intervention powers, only the sampling variables are changed according to Eqs. (1)-(3) and not by the envelope.

In some aspects, the results of the fluid flow simulator are used to understand and optimize the production of oil and natural gas from the regions of the subsurface. The results of the fluid flow simulator are used to plan and organize oil and natural gas production in the regions. For example, after the target variables have been computed for the target locations (e.g., by block 110), the target variables may be input to a fluid flow simulator that models and identifies boundaries and locations of petroleum reservoirs in the regions of the subsurface. The subsurface may then be surveyed to confirm the boundaries and locations of the petroleum reservoirs that correspond to the modeled fluid flow in the petroleum reservoir. Petroleum extraction from the reservoir may be executed based on the locations, boundaries, and discovered properties of the petroleum reservoir obtained from the determined target variables as described above.

### Training a Decision Tree Ensemble for Use in Reservoir Property Modeling

FIG. 2 depicts an example method 200 for training operations of an ML ensemble. For example, training an ML decision tree ensemble to generate a trained decision forest that is used in reservoir property modeling as in method 100 of FIG. 1, to predict a value of a target variable for a location within a subsurface reservoir given an input data vector of observations for that location.

The example method 200 begins at block 201 with collecting training data for locations at which the target variable is known, e.g., well locations. The training data includes a value for one or more secondary variables that characterize a geophysical attribute or property (such as seismic attributes) at the particular location in a reservoir as well as a ground truth label (known value) for a target variable that characterizes a geophysical attribute or property (such as porosity or permeability) at the particular location in the reservoir. The training data, including the value for one or more secondary variables and the ground truth label (known value) for the target variable, can be measured by surveys, well test analysis and interpretation, rock and fluid sampling and analysis, or other methods of reservoir characterization.

In block 203, an external model is used to predict and store an estimated value of the target variable at the particular location in the reservoir using available data but excluding the known target value at the particular location. This is known as embedding the model into the estimation procedure. For example, in an embodiment where the target variable represents porosity of the reservoir, a petrophysical model such as a Kriging model for porosity can be embedded. That is, it is used to predict and store an estimated value for the target variable porosity at the particular training location in the reservoir.

In block 205, a training data vector associated with a particular location in the reservoir is generated or built. The training data vector includes the secondary variable training data of 201 and the predicted value for the target variable of 203. The training data vector is associated with the ground truth label (known value) for the target variable at the particular location in the reservoir.

In block 207, the operations check whether the operations of 201 to 205 should be repeated for additional locations in the same reservoir. If so (e.g., for the case where sufficient training data has not yet been collected), the operations revert back to 201 to repeat the operations of 201 to 205 for additional locations in the same reservoir. If not (e.g., for the case where sufficient training data has been collected), the operations continue to block 209. The amount of data to be collected or deemed sufficient may be based on user set parameters.

In block 209, the training data vector samples and associated target variable ground truth labels of 205 for different particular locations (training locations) in the same reservoir are collected and stored for training the ensemble of ML models.

In block 211, the training data vector samples and associated target variable ground truth labels that are collected and stored in 209 are used to train an ensemble of ML models (e.g., an ML decision tree ensemble) to predict a value for the target variable (e.g., porosity or permeability) and optionally associated uncertainty (or other product) given an input data vector corresponding to the training data vector samples.

FIG. 3 depicts an example 300 of an ML ensemble, e.g., ML decision tree ensemble. The ML ensemble includes a set of two or more ML models (labeled ML Model 1 301, ML Model 2 302, etc.) that are trained using the training data vector samples 303 (and their associated target variable ground truth labels) that are collected and stored at block 209 of FIG. 2. The number of ML models may extend beyond two but only two are shown for simplicity.

In some aspects, the ML ensemble includes an ML decision tree ensemble. The training operations can employ random sampling of the training data vector samples 303 that are collected and stored in 209 of FIG. 2, such as through randomized feature bagging or other means to produce sample data 304.

During training rounds of each ML model of the ML ensemble, e.g., the ML models 301, 302, each ML model receives the sample data 304 of the training data vector samples 303 (the sample data 304 may also include associated ground truth labels) that can be used as training data inputs. Each ML model then uses these training data inputs to generate outputs of a predicted value ŷ for a target variable. For example, the ML model 1 301 outputs the predicted target variable value ŷ 305, and the ML model 2 302 outputs the predicted target variable value ŷ 306, based on the sampling data 304 they each receive.

For each ML model being trained, the predicted target variable value ŷ is compared with the ground truth label associated with it, and the difference is used to compute a cost function. A cost function is also known as a loss function and measures the difference between the predicted output (target variable value ŷ) and the ground truth value associated with the sample data 304 used to predict the value ŷ. For example, during the training of the ML models 301, the cost function 310 is computed as the difference between the. predicted target variable value ŷ 305 and the ground truth 308. Similarly, during the training of the ML models 302, the cost function 311 is computed as the difference between the predicted target variable value ŷ 307 and the ground truth 309.

The training of ML models continues with adjusting parameters of each ML model to minimize the cost function, and the training is repeated until the cost function is within acceptable parameters (this may be set by a user). For example, adjusting parameters of the ML model 1 301 occurs at 312 to minimize the cost function 310. Similarly, adjusting parameters of the ML model 2 302 occurs at 313 to minimize the cost function 311.

### Results from Testing Multiple Intervention Capabilities

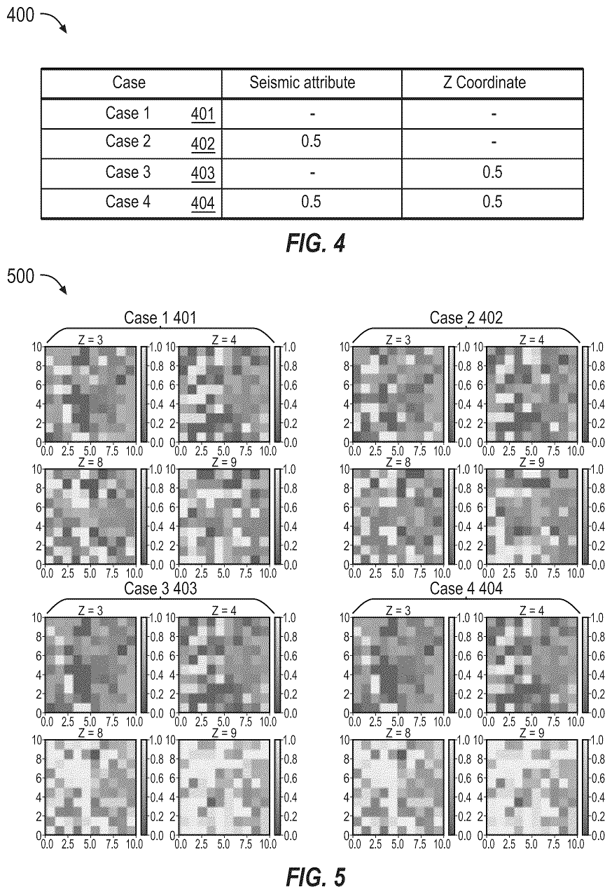

FIGS. 4-6 display example results obtained from executing the method 100 of FIG. 1 for various intervention variables and intervention powers.

FIG. 4. Depicts a table 400 with the values of target variables generated using the decision forest ranged from 0 to 1. A grid consisting of 1,000 (=10×10×10) cells and 40 data samples (4 locations with 10 layers) was used, where each sample has I, J, K, X, Y, Z indices/coordinates and one input seismic attribute that varies from 0 to 1. The decision forest was created with a total of 500 decision trees that were trained using given samples. Indices (I, J, K) are used to specify a particular cell within a grid, ranging from (1,1,1) to (nx, ny, nz), where nx, ny, and nz represent the total number of cells along the x, y, and z dimensions, respectively. In contrast, x, y, and z are the actual coordinates with floating-point values that correspond to specific positions of a cell within the grid.

To test the developed multiple intervention workflow shown in FIG. 1, four different sampling scenarios were used. Case 1 401 is a no-intervention case. Case 2 and 3 (402 and 403, respectively) are the single intervention cases using the seismic attribute and Z coordinate as an intervention variable, respectively. Case 4 404 is the multiple intervention case with both the seismic attribute and Z coordinate.

FIG. 5 shows a conditional simulation 500 of the target variable of four different z layers for various sampling scenarios. The z layer represents the different depth layers in the subsurface. These results confirmed that all four cases (case 1 401, case 2 402, case 3 403, and case 4 404) show different target fields due to different sampling from the envelope using different intervention strategies.

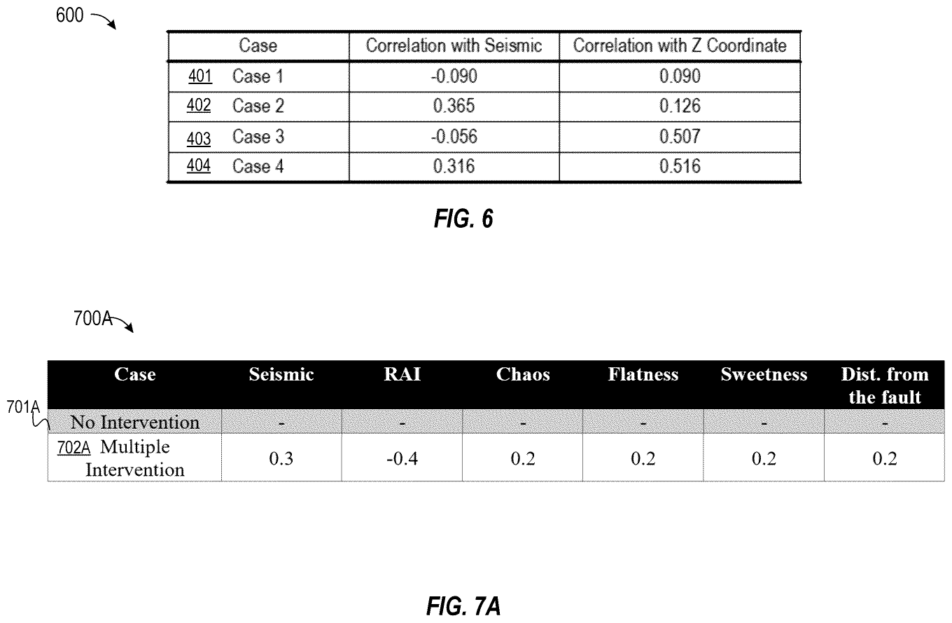

FIG. 6 displays a table 600 of correlations between the target variable and two intervention variables for four different cases. Case 1 401 shows that the correlations between the target and two intervention variables are small (|ρ|<0.1) when no intervention sampling is used. For Cases 2-3 (402 and 403), however, correlations between the target and intervention variables were increased while changing the correlation with the non-intervention variable slightly. Case 4 404 shows that the multiple intervention worked correctly so that correlations between the target and both intervention variables were increased significantly compared to Case 1 401. The objective of interventions is to produce scenarios that are different from one another, that depend on the intervention variable and that are consistent with the envelope (to produce a wide range of scenarios influenced by the secondary variables). The purpose of using multiple interventions is to provide multiple scenarios which could be called and controlled parametrically by an external optimizing algorithm, e.g., a history matching algorithm. This would allow the external optimizing algorithm access to a wider search space than is available from a simple ‘gaussian’ sample of the envelope—and more particularly it would provide a far larger workspace than traditional multigaussian geostatistical simulation algorithms. In the examples presented in case 1 401-case 4 404 the intervention powers (or correlations) used to generate the sampling variable in Equations (1) through (4) are set to 0.5. This setting affects the sampling variable rather than directly reflecting the correlation between the target variable and the intervention variable. Generally, a correlation coefficient of 0.5 indicates a moderate positive correlation between two variables.

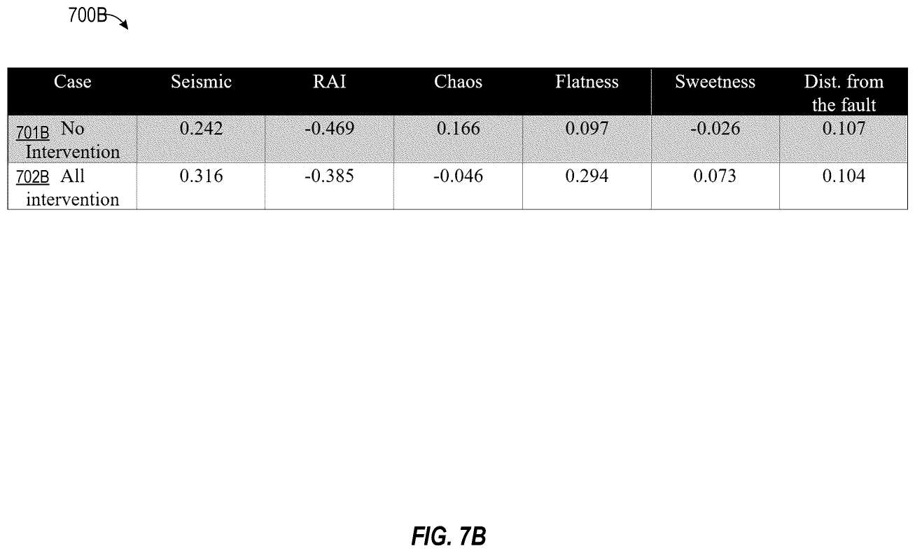

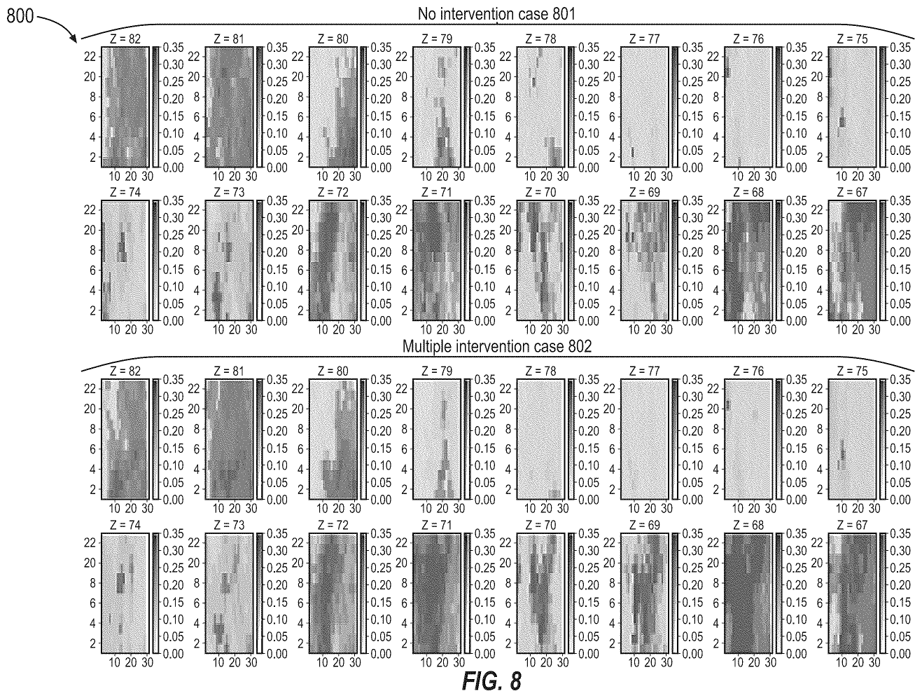

FIGS. 7-8 depict applications of multiple intervention capability. After testing the multiple intervention capability in a model, a porosity map was generated for a more realistic synthetic case. The grid consisted of 31×12×16 (=5,952) cells, and samples from two wells with 16 layers were given, where each sample has 1 input seismic data, 4 input seismic attributes (RAI, chaos, flatness, sweetness) and 7 geometrical variables (I, J, K, x, y, z, distance from fault). The decision forest was trained with a total of 500 decision trees and the two sampling strategies were used: (a) no-intervention case 701A, (b) a multiple intervention case 702A ousing 6 secondary variables (1 seismic+4 seismic attributes+distance from a fault) with intervention powers shown by 700A in FIG. 7A.

FIG. 7B demonstrates how correlations 700B between porosity and intervention variables are altered due to the capability of multiple interventions. A no intervention row 701B is shown as compared to a multiple intervention row 702B, e.g., one that applies all available interventions. Most of the correlations between the intervention and target variables are adjusted as intended. However, in the case of multiple interventions row 702B, complex correlations between intervention variables may exist, leading to unexpected outcomes. For example, the correlation between chaos and the target variable changes from a positive correlation of 0.166 to a small negative correlation of −0.046, even though the desired correlation for generating the sampling variables was set to a positive 0.2.

FIG. 8 depicts graphically a conditional simulation 800 of porosity for a no intervention case 801 and a multiple intervention case 802. FIG. 8 graphically depicts a conditional simulation 800 of porosity for two scenarios: a no intervention case 801 and a multiple intervention case 802. It is evident that the generated fields differ significantly due to the capability of multiple interventions.

### Example Method for Reservoir Property Modeling

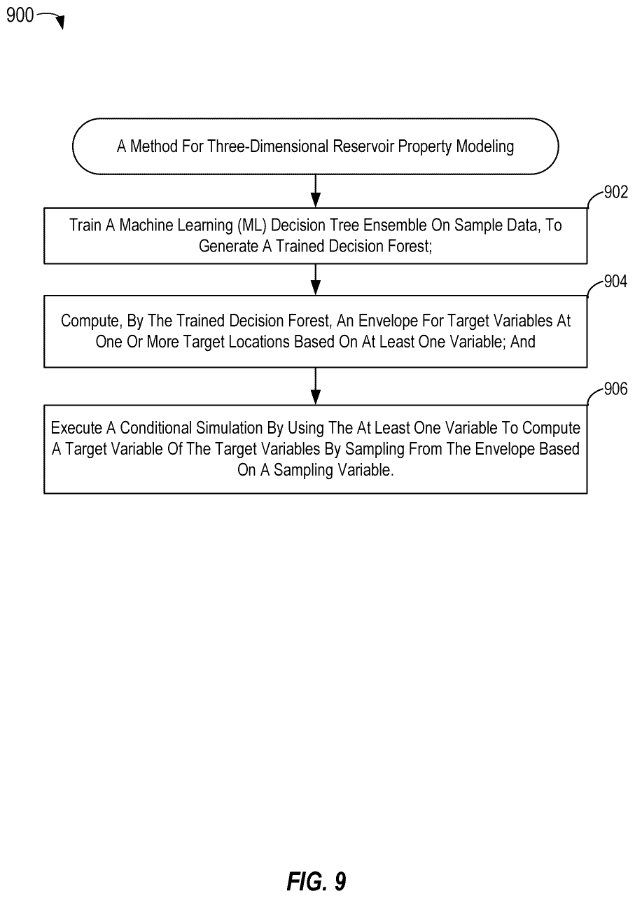

FIG. 9 depicts an example method 900 for reservoir property modeling.

The method 900 begins at block 902 with training a ML decision tree ensemble on sample data, to generate a trained decision forest, e.g., as described in FIGS. 2-3. Block 902 may, for example, also correspond to block 101 of FIG. 1.

Method 900 then continues at block 904 with computing, by the trained decision forest, an envelope for target variables at one or more target locations based on at least one variable. For example, the computation of block 904 may occur by passing secondary variables (plus embedding variables) down to the trained decision forest to derive the envelope for each target location where the target variable needs to be estimated as described in relation to FIG. 1.

Method 900 may continue at block 906 with executing a conditional simulation by using the at least one variable to compute a target variable of the target location by sampling from the envelope based on a sampling variable. This for example may correspond to running the conditional simulation as described by blocks 102-110 of FIG. 1. The at least one variable may include intervention variables and intervention powers.

In some aspects, method 900 may also include generating a model fluid flow of a petroleum reservoir of a subsurface based on the target variable by using a fluid flow simulator.

In some aspects, method 900 may also include conducting a survey of the subsurface to identify locations and boundaries of the petroleum reservoir that correspond to the model fluid flow of the petroleum reservoir; and extracting petroleum from the reservoir based on the locations and boundaries of the petroleum reservoir obtained in the survey.

In some aspects, method 900 may also include receiving a first input comprising a target location of the one or more target locations; receiving a second input comprising at least one variable, the at least one variable comprising at least one of one or more intervention variables or one or more intervention powers for the target location; computing a range of quantiles that correspond to a portion of the sample data associated with a sample location; transforming the envelope of the target variables and the intervention variables to a standard normal distribution for the target location; computing a range of quantiles of a residual at one or more sample locations of a subsurface based on the at least one variable; performing a stochastic simulation of the residuals of the subsurface to condition the one or more sample locations based on an inverse distribution of the envelope; computing the target variables transformed to a standard normal distribution for the target location; generating the sampling variable at the target location from the standard normal distribution; and computing the target variable at the target location by sampling from the envelope based on the sampling variable.

In some aspects of method 900 the training of the ML decision tree ensemble uses training data as well as additional data derived from at least one external model, wherein the additional data provides information that supplements the information contained in the training data.

In some aspects method 900 includes constructing a plurality of training data vectors, wherein each training data vector includes the training data and the additional data derived from the at least one external model; and using the plurality of training data vectors to train the ML decision tree ensemble.

In some aspects of method 900 the training data is derived from the sampling data, wherein the sampling data comprises one or more secondary variables.

In some aspects of method 900 the secondary variables characterize a geophysical attribute or property.

In some aspects of method 900 the intervention variables are external variables selected from secondary variables used for the training.

In some aspects of method 900 the intervention power is a correlation between the target variable and the intervention variables for computing the sampling variable at the target location.

In some aspects of method 900 each target location of the one or more target locations corresponds to a volume of the Earth.

### Example Processing System for Reservoir Property Modeling

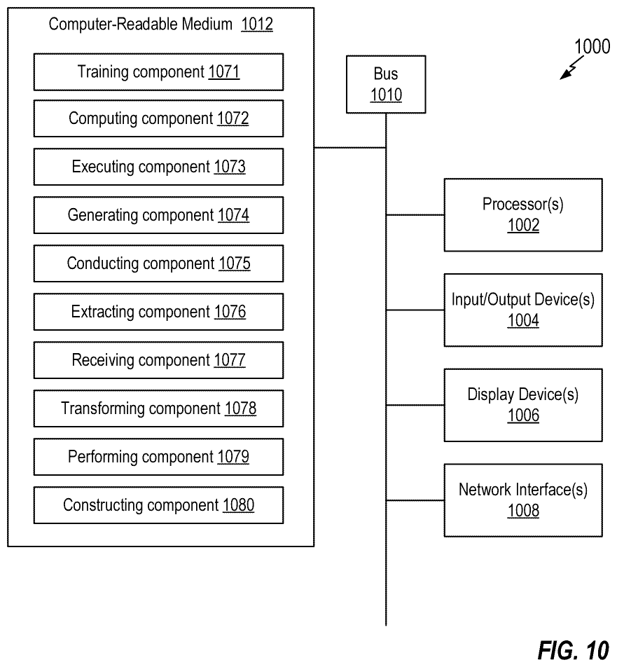

FIG. 10 depicts an example processing system 1000 configured to perform various aspects described herein, including, for example, methods 100, 200, and 900 as described above with respect to FIGS. 1-2 and 9.

Processing system 1000 is an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1000 includes one or more processors 1002, one or more input/output devices 1004, one or more display devices 1006, one or more network interfaces 1008 through which processing system 1000 is connected to one or more networks (e.g., a local network, an intranet, the Internet, or any other group of processing systems communicatively connected to each other), and computer-readable medium 1012. In the depicted example, the aforementioned components are coupled by a bus 1010, which may generally be configured for data exchange amongst the components. Bus 1010 may be representative of multiple buses, while only one is depicted for simplicity.

Processor(s) 1002 are generally configured to retrieve and execute instructions stored in one or more memories, including local memories like computer-readable medium 1012, as well as remote memories and data stores. Similarly, processor(s) 1002 are configured to store application data residing in local memories like the computer-readable medium 1012, as well as remote memories and data stores. More generally, bus 1010 is configured to transmit programming instructions and application data among the processor(s) 1002, display device(s) 1006, network interface(s) 1008, and/or computer-readable medium 1012. In certain embodiments, processor(s) 1002 are representative of a one or more central processing units (CPUs), graphics processing unit (GPUs), tensor processing unit (TPUs), accelerators, and other processing devices.

Input/output device(s) 1004 may include any device, mechanism, system, interactive display, and/or various other hardware and software components for communicating information between processing system 1000 and a user of processing system 1000. For example, input/output device(s) 1004 may include input hardware, such as a keyboard, touch screen, button, microphone, speaker, and/or other device for receiving inputs from the user and sending outputs to the user.

Display device(s) 1006 may generally include any sort of device configured to display data, information, graphics, user interface elements, and the like to a user. For example, display device(s) 1006 may include internal and external displays such as an internal display of a tablet computer or an external display for a server computer or a projector. Display device(s) 1006 may further include displays for devices, such as augmented, virtual, and/or extended reality devices. In various embodiments, display device(s) 1016 may be configured to display a graphical user interface.

Network interface(s) 1008 provide processing system 1000 with access to external networks and thereby to external processing systems. Network interface(s) 1008 can generally be any hardware and/or software capable of transmitting and/or receiving data via a wired or wireless network connection. Accordingly, network interface(s) 1008 can include a communication transceiver for sending and/or receiving any wired and/or wireless communication.

Computer-readable medium 1012 may be a volatile memory, such as a random-access memory (RAM), or a nonvolatile memory, such as nonvolatile random-access memory (NVRAM), or the like. In this example, computer-readable medium 1012 includes a training component 1071, a computing component 1072, an executing component 1073, a generating component 1074, a conducting component 1075, an extracting component 1076, a receiving component 1077, a transforming component 1078, a performing component 1079, and a constructing component 1080.

In certain embodiments, the training component 1071 is configured to train an ML decision tree ensemble on sample data, to generate a trained decision forest, the computing component 1072 is configured to compute, by the trained decision forest, an envelope for target variables at one or more target locations based on secondary variables, and the executing component 1073 is configured to execute a conditional simulation to compute a target variable of the target variables by sampling from the envelope based on the at least one variable. In some aspects, the generating component 1074 is configured to generate a model fluid flow of a petroleum reservoir of a subsurface based on the target variable by using a fluid flow simulator. In some aspects, the conducting component 0175 is configured to conduct a survey of the subsurface to identify locations and boundaries of the petroleum reservoir that correspond to the model fluid flow of the petroleum reservoir, and the extracting component 1076 is configured to extract petroleum from the reservoir based on the locations and boundaries of the petroleum reservoir obtained in the survey.

In some aspects, the receiving component 1077 is configured to receive a first input comprising a target location of the one or more target locations or receive a second input comprising at least one variable, the at least one variable comprising at least one of one or more intervention variables or one or more intervention powers for the target location.

In some aspects, the transforming component 1077 is configured to transform the envelope of the target variables and the intervention variables to a standard normal distribution for the target location.

In some aspects, the performing component 1079 is configured to, and the constructing component 1080 is configured construct a plurality of training data vectors, wherein each training data vector includes the training data and the additional data derived from the at least one external model.

Note that FIG. 10 is just one example of a processing system consistent with aspects described herein, and other processing systems having additional, alternative, or fewer components are possible consistent with this disclosure.

### Example Clauses

Implementation examples are described in the following numbered clauses:

Clause 1: A method for reservoir property modeling, comprising training a machine learning (ML) decision tree ensemble on sample data, to generate a trained decision forest; computing, by the trained decision forest, an envelope for target variables at one or more target locations based on at least one variable; and executing a conditional simulation by using the at least one variable to compute a target variable of the target variables by sampling from the envelope based on a sampling variable.

Clause 2: The method of claim 1 wherein executing of the conditional simulation comprises receiving a first input comprising one or more target locations; and receiving a second input comprising the at least one variable, the at least one variable comprising at least one of one or more intervention variables or one or more intervention powers for the one or more target locations.

Clause 3: The method of any one of Clauses 1-2 wherein executing of the conditional simulation further comprises computing a range of quantiles that correspond to a portion of the sample data, the portion of the sample data associated with one or more sample locations; transforming the envelope of the target variables and the intervention variables to a standard normal distribution for the one or more target locations; computing a range of quantiles of a residual at one or more sample locations of a subsurface based on the at least one variable; performing a stochastic simulation of the residuals of the subsurface to condition the one or more sample locations based on an inverse distribution of the envelope; computing the target variables transformed to a standard normal distribution for a target location of the one or more target locations; generating a sampling variable at the target location from a quantile of the standard normal distribution; and computing the target variable at the target location by sampling from the envelope based on the sampling variable.

Clause 4: The method of any one of Clauses 1-3 further comprising generating a model fluid flow of a petroleum reservoir of a subsurface based on the target variable by using a fluid flow simulator.

Clause 5: The method of any of Clauses 1-4, further comprising conducting a survey of the subsurface to identify locations and boundaries of the petroleum reservoir that correspond to the model fluid flow of the petroleum reservoir; and extracting petroleum from the reservoir based on the locations and boundaries of the petroleum reservoir obtained in the survey.

Clause 6: The method of any of Clauses 1-5, wherein the training of the ML decision tree ensemble uses training data as well as additional data derived from at least one external model, wherein the additional data provides information that supplements the information contained in the training data.

Clause 7: The method any of Clauses 1-6, further comprising constructing a plurality of training data vectors, wherein each training data vector comprises the training data and the additional data derived from the at least one external model; and training the ML decision tree ensemble by using the plurality of training data vectors.

Clause 8: The method any of Clauses 1-7, wherein training data of each training data vector of the training data vectors comprises at least one observation that characterizes a reservoir property or attribute.

Clause 9: The method any of Clauses 1-8, wherein the training data is derived from the sample data, wherein the sample data comprises one or more secondary variables.

Clause 10: The method any of Clauses 1-9, wherein the one or more secondary variables characterize a geophysical attribute or property.

Clause 11: The method any of Clauses 1-10, wherein the one or more intervention variables are external variables selected from secondary variables used for the training.

Clause 12: The method any of Clauses 1-11, wherein each intervention power of the one or more intervention powers is a correlation between the target variable and an intervention variable of the one or more intervention variables for computing the sampling variable at a target location of the one or more target locations.

Clause 13: A processing system, comprising one or more memories comprising computer-executable instructions; and one or more processors configured to execute the computer-executable instructions and cause the processing system to: train a machine learning (ML) decision tree ensemble on sample data, to generate a trained decision forest; compute, by the trained decision forest, an envelope for target variables at one or more target locations based on at least one variable; and execute a conditional simulation by using the at least one variable to compute a target variable of the target variables by sampling from the envelope based on a sampling variable.

Clause 14: The processing system of claim 13, wherein the one or more processors are further configured to cause the processing system to generate a model fluid flow of a petroleum reservoir of a subsurface based on the target variable by using a fluid flow simulator.

Clause 15: The processing system of any of Clauses 13-14, wherein the one or more processors are further configured to cause the processing system to survey the subsurface to identify locations and boundaries of the petroleum reservoir that correspond to the modeled fluid flow in the petroleum reservoir; and execute petroleum extraction from the reservoir based on the locations and boundaries of the petroleum reservoir obtained in the survey.

Clause 16: The processing system of any of Clauses 13-15, wherein to execute the conditional simulation, the one or more processors are further configured to cause the processing system to receive a first input comprising one or more target locations; receive a second input comprising at least one variable, the at least one variable comprising at least one of one or more intervention variables or one or more intervention powers for the one or more target locations; compute a range of quantiles that correspond to a portion of the sample data, the portion of the sample data associated with one or more sample locations; transform the envelope of the target variables and the intervention variables to a standard normal distribution for the one or more target locations; compute a range of quantiles of a residual at one or more sample locations of a subsurface based on the at least one variable; perform a stochastic simulation of the residuals of the subsurface to condition the one or more sample locations based on an inverse distribution of the envelope; compute the target variables transformed to a standard normal distribution for a target location of the one or more target locations; generate the sampling variable at the target location from the standard normal distribution; and compute the target variable at the target location by sampling from the envelope based on the sampling variable.

Clause 17: The processing system of any of Clauses 13-16, wherein to train the ML decision tree ensemble uses training data as well as additional data derived from at least one external model, wherein the additional data provides information that supplements the information contained in the training data.

Clause 18: The processing system of any of Clauses 13-17, wherein to train the ML decision tree ensemble the processor is further configured to cause the processing system to construct a plurality of training data vectors, wherein each training data vector includes the training data and the additional data derived from the at least one external model; and use the plurality of training data vectors to train the ML decision tree ensemble.

Clause 19: A non-transitory computer-readable medium comprising instructions that, when executed by one or more processors of a computing system, cause the computing system to perform operations for reservoir property modeling, the operations comprising training a machine learning (ML) decision tree ensemble on sample data, to generate a trained decision forest; computing, by the trained decision forest, an envelope for target variables at one or more target locations based on at least one variable, the at least one variable comprising one or more intervention variables or one or more power variables; and executing a conditional simulation by using the at least one variable to compute a target variable of the target variables by sampling from the envelope based on a sampling variable.

Clause 20: The non-transitory computer-readable medium of Clause 19, wherein executing the conditional simulation comprises receiving a first input one or more target locations; receiving a second input comprising the at least one variable, the at least one variable comprising at least one of one or more intervention variables or one or more intervention powers for the one or more target locations; computing a range of quantiles that correspond to a portion of the sample data, the portion of the sample data associated with one or more sample locations; transforming the envelope of the target variables and the intervention variables to a standard normal distribution for the one or more target locations; computing a range of quantiles of a residual at one or more sample locations of a subsurface based on the at least one variable; performing a stochastic simulation of the residuals of the subsurface to condition the one or more sample locations based on an inverse distribution of the envelope; computing the target variables transformed to a standard normal distribution for a target location of the one or more target locations; generating a sampling variable at the target location from a quantile of the standard normal distribution; and computing the target variable at the target location by sampling from the envelope based on the sampling variable.

Clause 21: One or more processing systems, comprising: one or more memories comprising computer-executable instructions; and one or more processors configured to execute the computer-executable instructions and cause the one or more processing systems to perform a method in accordance with any one of Clauses 1-20.

Clause 22: One or more processing systems, comprising means for performing a method in accordance with any one of Clauses 1-20.

Clause 23: One or more non-transitory computer-readable media comprising instructions that, when executed by one or more processors of a computing system, cause the computing system to perform the operations of any one of Clauses 1-20.

Clause 24: One or more computer program products embodied on one or more computer-readable storage media comprising code for performing a method in accordance with any one of Clauses 1-20.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, unless stated otherwise, the term “or” is used in an inclusive sense. This inclusive usage of or is equivalent to “and/or”. Thus, when options are delineated using “or” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. ŷ 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for reservoir property modeling, comprising:
training a machine learning (ML) decision tree ensemble on sample data, to generate a trained decision forest;
computing, by the trained decision forest, an envelope for target variables at one or more target locations based on at least one variable; and
executing a conditional simulation by using the at least one variable to compute a target variable of the target location by sampling from the envelope based on a sampling variable.

2. The method of claim 1 wherein executing of the conditional simulation comprises:
receiving a first input comprising one or more target locations; and
receiving a second input comprising the at least one variable, the at least one variable comprising at least one of one or more intervention variables or one or more intervention powers for the one or more target locations.

3. The method of claim 2 wherein executing of the conditional simulation further comprises:
computing a range of quantiles that correspond to a portion of the sample data, the portion of the sample data associated with one or more sample locations;
transforming the envelope of the target variables and the intervention variables to a standard normal distribution for the one or more target locations;
computing a range of quantiles of a residual at one or more sample locations of a subsurface based on the at least one variable;
performing a stochastic simulation of the residuals of the subsurface to condition the one or more sample locations based on an inverse distribution of the envelope;
computing the target variables transformed to a standard normal distribution for a target location of the one or more target locations;
generating a sampling variable at the target location from a quantile of the standard normal distribution; and
computing the target variable at the target location by sampling from the envelope based on the sampling variable.

4. The method of claim 1 further comprising generating a model fluid flow of a petroleum reservoir of a subsurface based on the target variable by using a fluid flow simulator.

5. The method of claim 4, further comprising:
conducting a survey of the subsurface to identify locations and boundaries of the petroleum reservoir that correspond to the model fluid flow of the petroleum reservoir; and
extracting petroleum from the reservoir based on the locations and boundaries of the petroleum reservoir obtained in the survey.

6. The method of claim 1, wherein the training of the ML decision tree ensemble uses training data as well as additional data derived from at least one external model, wherein the additional data provides information that supplements the information contained in the training data.

7. The method of claim 6, further comprising:
constructing a plurality of training data vectors, wherein each training data vector comprises the training data and the additional data derived from the at least one external model; and
training the ML decision tree ensemble by using the plurality of training data vectors.

8. The method of claim 7, wherein training data of each training data vector of the training data vectors comprises at least one observation that characterizes a reservoir property or attribute.

9. The method of claim 6 wherein the training data is derived from the sample data, wherein the sample data comprises one or more secondary variables.

10. The method of claim 9, wherein the one or more secondary variables characterize a geophysical attribute or property.

11. The method of claim 2, wherein the one or more intervention variables are external variables selected from secondary variables used for the training.

12. The method of claim 2, wherein each intervention power of the one or more intervention powers is a correlation between the target variable and an intervention variable of the one or more intervention variables for computing the sampling variable at a target location of the one or more target locations.

13. A processing system, comprising:
one or more memories comprising computer-executable instructions; and
one or more processors configured to execute the computer-executable instructions and cause the processing system to:
train a machine learning (ML) decision tree ensemble on sample data, to generate a trained decision forest;
compute, by the trained decision forest, an envelope for target variables at one or more target locations based on at least one variable; and
execute a conditional simulation by using the at least one variable to compute a target variable of the target variables by sampling from the envelope based on a sampling variable.

14. The processing system of claim 13, wherein the one or more processors are further configured to cause the processing system to:
generate a model fluid flow of a petroleum reservoir of a subsurface based on the target variable by using a fluid flow simulator.

15. The processing system of claim 14, wherein the one or more processors are further configured to cause the processing system to:
survey the subsurface to identify locations and boundaries of the petroleum reservoir that correspond to the modeled fluid flow in the petroleum reservoir; and
execute petroleum extraction from the reservoir based on the locations and boundaries of the petroleum reservoir obtained in the survey.

16. The processing system of claim 13, wherein to execute the conditional simulation, the one or more processors are further configured to cause the processing system to:
receive a first input comprising one or more target locations;
receive a second input comprising at least one variable, the at least one variable comprising at least one of one or more intervention variables or one or more intervention powers for the one or more target locations;
compute a range of quantiles that correspond to a portion of the sample data, the portion of the sample data associated with one or more sample locations;
transform the envelope of the target variables and the intervention variables to a standard normal distribution for the one or more target locations;
compute a range of quantiles of a residual at one or more sample locations of a subsurface based on the at least one variable;
perform a stochastic simulation of the residuals of the subsurface to condition the one or more sample locations based on an inverse distribution of the envelope;
compute the target variables transformed to a standard normal distribution for a target location of the one or more target locations;
generate the sampling variable at the target location from the standard normal distribution; and
compute the target variable at the target location by sampling from the envelope based on the sampling variable.

17. The processing system of claim 13, wherein to train the ML decision tree ensemble uses training data as well as additional data derived from at least one external model, wherein the additional data provides information that supplements the information contained in the training data.

18. The processing system of claim 17, wherein to train the ML decision tree ensemble the processor is further configured to cause the processing system to:
construct a plurality of training data vectors, wherein each training data vector includes the training data and the additional data derived from the at least one external model; and
use the plurality of training data vectors to train the ML decision tree ensemble.

19. A non-transitory computer-readable medium comprising instructions that, when executed by one or more processors of a computing system, cause the computing system to perform operations for reservoir property modeling, the operations comprising:
training a machine learning (ML) decision tree ensemble on sample data, to generate a trained decision forest;
computing, by the trained decision forest, an envelope for target variables at one or more target locations based on at least one variable, the at least one variable comprising one or more intervention variables or one or more power variables; and
executing a conditional simulation by using the at least one variable to compute a target variable of the target variables by sampling from the envelope based on a sampling variable.

20. The non-transitory computer-readable medium of claim 19, wherein executing the conditional simulation comprises:
receiving a first input one or more target locations;
receiving a second input comprising the at least one variable, the at least one variable comprising at least one of one or more intervention variables or one or more intervention powers for the one or more target locations;
computing a range of quantiles that correspond to a portion of the sample data, the portion of the sample data associated with one or more sample locations;
transforming the envelope of the target variables and the intervention variables to a standard normal distribution for the one or more target locations;
computing a range of quantiles of a residual at one or more sample locations of a subsurface based on the at least one variable;
performing a stochastic simulation of the residuals of the subsurface to condition the one or more sample locations based on an inverse distribution of the envelope;
computing the target variables transformed to a standard normal distribution for a target location of the one or more target locations;
generating a sampling variable at the target location from a quantile of the standard normal distribution; and
computing the target variable at the target location by sampling from the envelope based on the sampling variable.
